(19) United States
(12) Patent Application Publication
(10) Pub. No.: US 2009/0020125 A1
(43) Pub. Date: Jan. 22, 2009

(54) NASAL FILTER

(76) Inventor: WEN-SHIN CHANG, TAIPEI CITY (TW)

Correspondence Address: Muncy, Geissler, Olds & Lowe, PLLC, P.O. BOX 1364, FAIRFAX, VA, 22038-1364, US

(21) Appl. No.: 12/169,330

(22) Filed: Jul. 8, 2008

(30) Foreign Application Priority Data
Jul. 18, 2007 (TW) 096211712
Sep. 28, 2007 (TW) 096216255

(51) Int. Cl. A62B 23/06

(52) U.S. Cl. 128/206.11

(57) ABSTRACT

A nasal filter comprising two filter bodies, a connecting portion and two filter materials is provided. The filter body respectively has a top surface, a bottom surface and a first axial hole. The first axial hole penetrates the top surface and the bottom surface, and a first opening and a second opening respectively form on the top surface and the bottom surface. The diameter of the first opening is smaller than the diameter of the second opening. The connecting portion has two ends connected with the two filter bodies respectively. The two filter materials are respectively disposed in the two first axial holes, wherein the diameter of the filter material is greater than or equal to the diameter of the second opening.

This application claims priority based on a Taiwanese patent application No. 096211712 filed on Jul. 18, 2007 and No. 096216255 filed on Sep. 28, 2007.

### BACKGROUND OF THE INVENTION

1. Field of the Invention

The present invention relates to an insertable filter, and more particularly relates to a nasal filter to be inserted into the nasal cavity.

2. Description of the Prior Art

The demands for energy, drinking water and living environment are increasing as the population grows. The pollution problems affecting the environment are also getting worse. In particular, the technologies are developed fleetly, rising of large-scale industrial activities cause pollution by expelling smoke from factories or by the burning coal etc. such as lots of plant chimneys belch out dense smoke, coal combustion, etc. Moreover, people's massive usage on aircraft, automobiles or other vehicles, indeed, the offensive odour caused by the solid waste and chemical sprays (such as insecticide or hair spray) and smoke from cigarette may also pollute the air seriously.

As for various pollutions mentioned above, people usually use the gauze masks or gas masks to catch the dust, odour or stink, or even use them to separate the virus, bacteria or mite from people. For example, the police officer responsible for traffic control are exposed to toxic environment of fuliginosity and carbon dioxide but they can not wear the gauze mask or gas mask while controlling traffic by blowing whistle. Furthermore, workers such as mineworkers, construction workers or other workers are exposed to high aerosol environment. When accident occurs they cannot shout while wearing gauze mask or gas mask that may affect the disaster control. Thus, the life and health condition of people working in highly polluted environment are very often threatened.

Therefore, the conventional gauze masks or gas masks are still not applicative/practical or satisfied/satisfactory in accordance with the demands of modern society.

### SUMMARY OF THE INVENTION

It is an objective of the present invention to provide a nasal filter to filter aerosol, smoke or toxic gas.

It is another objective of the present invention to provide a nasal filter that can reduce the occupational disaster to preserve occupational disease caused by the air pollution.

It is another objective of the present invention to provide a nasal filter having functions of preventing allergy, filtering odour/stink or stimulating consciousness, etc.

The nasal filter of the present invention comprises two filter bodies, a connecting portion and two filter materials. Each of the filter bodies has a top surface, a bottom surface and a first axial hole respectively. The first axial hole penetrates the top surface and the bottom surface, and a first opening and a second opening form on the top surface and the bottom surface respectively. The diameter of the first opening is smaller than the diameter of the second opening. Two ends of the connecting portion connect with the two filter bodies respectively. The two filter materials are disposed in the two first axial holes respectively, wherein the diameter of filter materials are greater than or equal to the diameter of the second opening.

In a preferable embodiment, the two filter bodies preferably have shape such as a cylinder, sphere or other shapes. The connecting portion is preferably disposed on the bottom surface of the two filter bodies. However, in other embodiments, the two ends of the connecting portion may also be disposed on the outer surface of the two filter bodies. At least one brace is disposed on one end of the filter material for positioning a covering. A gap is further disposed close to the center of the brace while the covering has an extending portion and a protrusion portion disposed thereof. The diameter of the gap is smaller than the diameter of the protrusion portion, thereby the protrusion portion can restrict the brace by the gap, and thus the covering may move axially along the brace. In addition, the filter material further has a passageway corresponding to the covering for exhaustion, inhalation or other purposes.

In another preferable embodiment, the two filter bodies further have a first axial hole and a second axial hole, and an interval is formed between the second axial hole and the first axial hole. Each filter body preferably has an oval shape, an egg shape, a ring-tubby shape, a sphere shape, an ellipse-tubby shape or an ob-ovum ellipse tubby shape which is similar to the shape of the nasal cavity. The filter body has at least one brace disposed on the bottom surface of the second axial hole for positioning the covering, and thus the covering can move axially along the brace.

### BRIEF DESCRIPTION OF THE DRAWINGS

FIG. 1 illustrates a three-dimensional perspective view of the nasal filter according to the present invention;

FIG. 2 illustrates an exploded view of the nasal filter according to the present invention;

FIG. 3a illustrates another three-dimensional perspective view of the nasal filter according to another embodiment of the present invention;

FIG. 3b illustrates a perspective view of another preferable embodiment of the connecting portion according to the present invention;

FIG. 4 illustrates a perspective view of a covering disposed on one end of the filter material to be used together with the filter body;

FIG. 5a illustrates an operation view of the open covering according to the present invention;

FIG. 5b illustrates an operation view of the closed covering closed according to the present invention;

FIG. 6a illustrates another preferable embodiment view of the present invention;

FIG. 6b illustrates a planar perspective view of the embodiment shown in FIG. 6a; and

FIG. 7 illustrates an operation view of the present invention.

### DETAILED DESCRIPTION OF THE PREFERRED EMBODIMENT

The present invention relates to a nasal filter that prevents harmful substances from entering the respiratory tract. In the preferable embodiments, the nasal filter is using the filter body having a form similar to the nasal cavity that is to be inserted into the nasal cavity and will not come off the nostril. Furthermore, the nasal filter not only can be applied to the highly fuliginosity/carbon dioxide, polluted or hypersensitive environments; it can also be added with volatile substances (such as mint, balm, vanilla or other substrates) for purposes such stimulating consciousness, controlled smell and treating diseases. In order to illustrate the present invention, various embodiments and structure thereof are described below together with drawings.

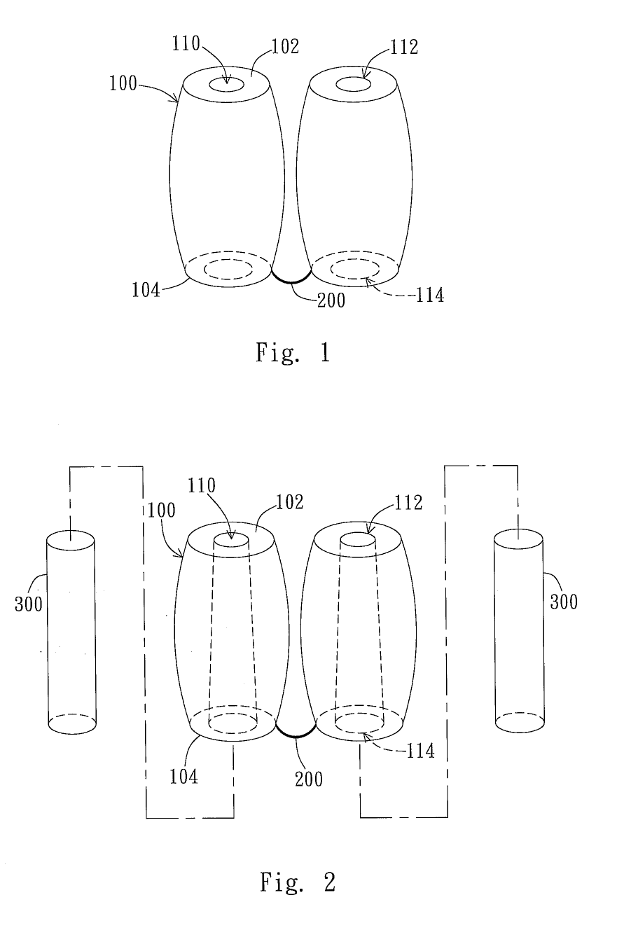

FIG. 1 and FIG. 2 illustrate a three-dimensional perspective view and an exploded view of the present invention. The nasal filter comprises two filter bodies 100, a connecting portion 200 and two filter materials 300. Each of the filter bodies 100 has a top surface 102 and a bottom surface 104. A first axial hole 110 is disposed in the filter body 100 and close to the center of the filter body 100. However, in other embodiments, the first axial hole 110 may also be disposed at the non-center locations of the filter body 100. The first axial hole 110 penetrates the top surface 102 and the bottom surface 104, and a first opening 112 and a second opening 114 are formed on the top surface 102 and the bottom surface 104 respectively. Particularly, the diameter of the first opening 112 is smaller than the diameter of the second opening 114.

In the embodiment shown in FIG. 2, the two filter materials 300 are inserted into the first axial hole 110 respectively. The diameter of the filter material 300 is preferably greater than or equal to the diameter of the second opening 114, and the shape of the filter material 300 is preferably a cylinder shape. However, in other embodiments, the filter material 300 may also be shaped into a cone, which is similar with the shape of the first axial hole 110. Accordingly, in the embodiment shown in FIG. 2, the material of each of the filter materials 300 preferably include filter-net, activating carbon material, non-woven fabric or filter cotton, etc. Due to the fact that the diameter of the filter material 300 is grater than or equal to the diameter of the second opening 114 while the diameter of the first opening 112 is much smaller than the diameter of the second opening 114. Thus, when the filter material 300 is inserted into the first axial hole 110, the filter material 300 will not be easily revealed or drawn form the first opening 112.

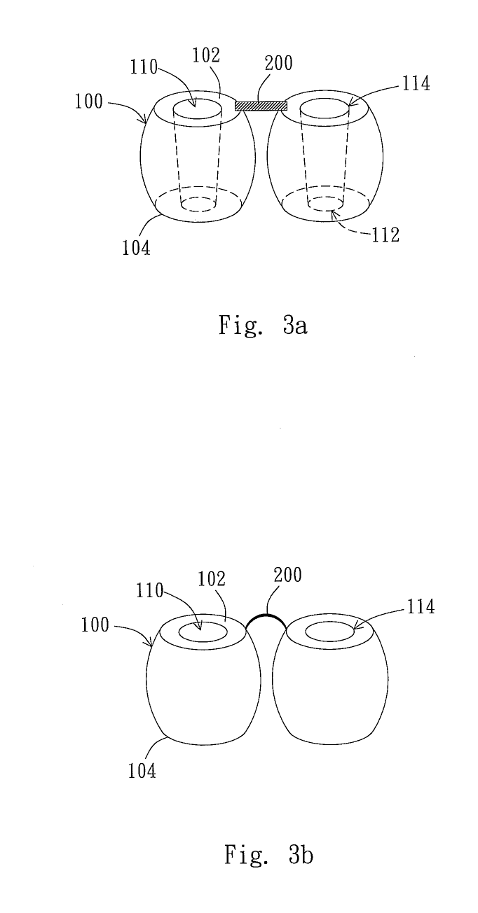

The two ends of the connecting portion 200 connect with the bottom surface 104 of the two filter bodies 100 respectively. In the embodiment shown in FIG. 1 and FIG. 2, the connecting portion 200 is preferably integrate with the two filter bodies 100. However, in other embodiments, the connecting portion 200 may be fabricated on the filter body 100 through secondary processing such as sticking, plastering, etc. Moreover, in the present embodiment, the shape of each of the filter bodies 100 is preferably a cylinder shape. However, in the embodiment shown in FIG. 3a and FIG. 3b, the shape of the filter body 100 may also be a sphere shape or other similar spherical shapes. The material of the connecting portion 200 is preferably similar with the material of the filter body 100, i.e. material selected from one of the group consisting of silica gel (silicon), plastic, rubber, PP, PE and the combinations thereof. In other words, the filter body 100 and the connecting portion 200 are preferably be made of an elastic materials or plastic materials. However, in other embodiments, the filter body 100 and/or the connecting portion 200 may also include a rigid material such as thermosetting plastic or other similar materials.

In the embodiment shown in FIG. 3a, the two ends of the connecting portion 200 are preferably connected to two of the bottom surface 104 of the filter bodies 100 respectively. However, in other embodiments shown in FIG. 3b, the two ends of the connecting portion 200 may also connect with the outer surface of the filter body 100.

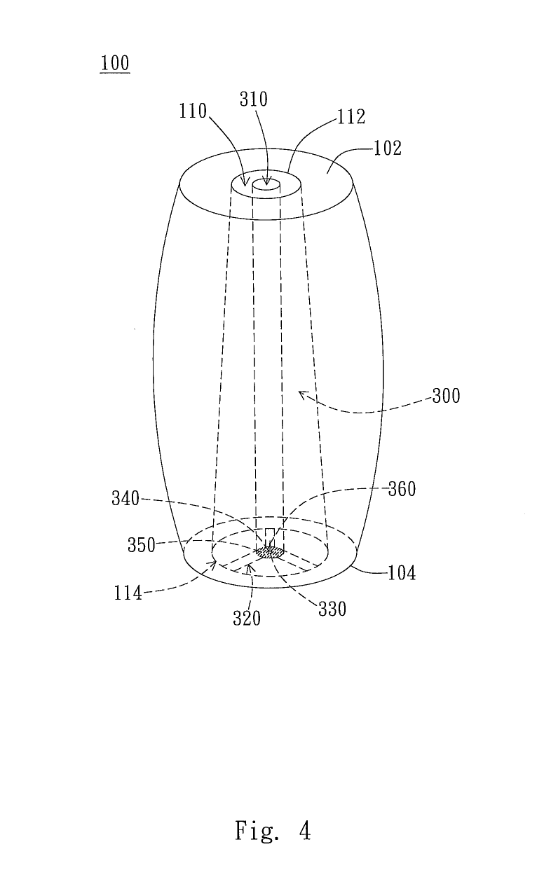

FIG. 4 shows a perspective view of the covering disposed on one end of the filter material to be used with the filter body according to the present invention. In order to increase the air exhalation/inhalation or other effects of the filter body 300, at least one brace 320 is disposed on one end of the filter material 300 for positioning the covering 350. In the embodiment shown in FIG. 4, the brace 320 is preferably disposed close to the bottom surface 104 of the filter body 100 and is preferably shaped in triangle. A gap 330 is disposed close to the center of the brace 320 provided for engaging with covering 350. Center of the covering 350 is disposed with an extending portion 360 and a protrusion portion 340 perpendicular to the covering 350, and the protrusion portion 340 is disposed on the extending portion 360. Due to the fact that the diameter of the gap 330 is smaller than the diameter of the protrusion portion 340, the protrusion portion 340 can engage the brace 320 via the gap 330, which allows the covering 350 to move axially along the brace 320 without coming off easily. Furthermore, in the present embodiment, the filter material 300 further has a passageway 310 disposed corresponding to the shape of the covering 350 for increasing air inhalation or discharging of the secretions of the nasal cavity.

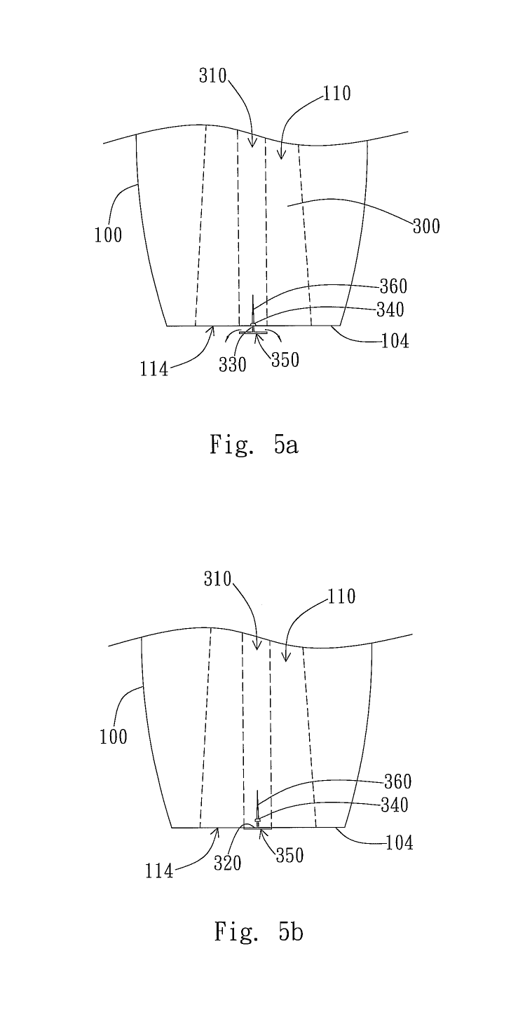

FIG. 5a and FIG. 5b show an operation view of the covering according to the present invention. In the embodiment shown in FIG. 5a, when the air moves from the top surface 102 toward the bottom surface 104, the covering 350 will be pushed downward easily by air, and the covering 350 is stopped by the protrusion portion 340 and the gap 330 to facilitate the air exhalation out of the filter body 100. In the embodiment shown in FIG. 5b, when the air moves from the bottom surface 104 towards the top surface 102, the covering 350 will be lifted upward easily by the air until making contact with the brace 320 and cover the entire passageway 310. In other words, during inhalation, the air must not enter the filter body 100 from the location of the covering 350, i.e. air must enter from the other locations of the second opening 114 in order to achieve the filtering effect.

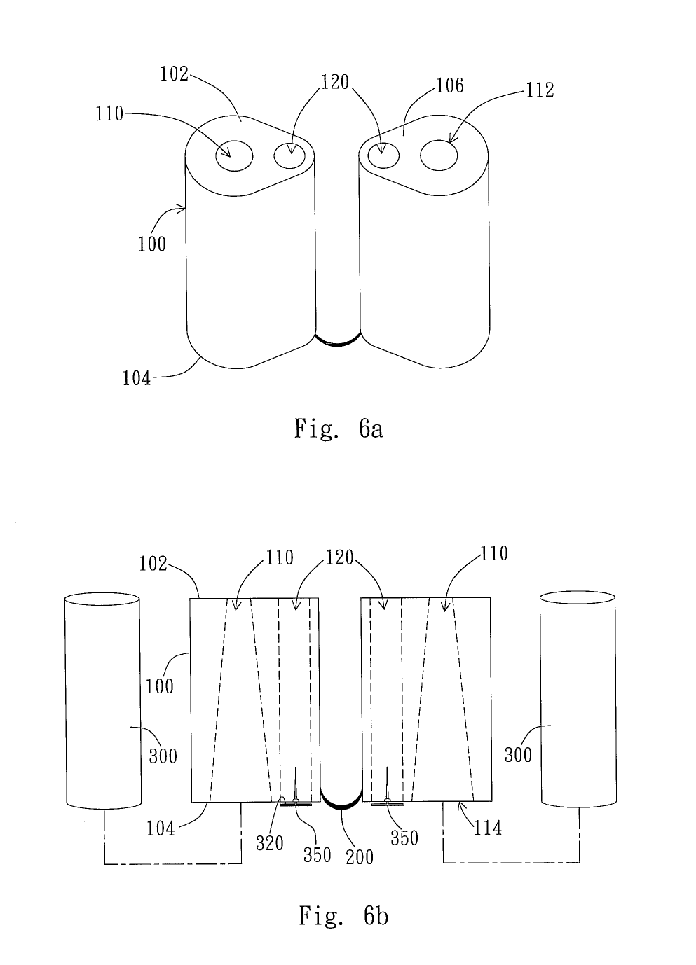

FIG. 6a and FIG. 6b show other perspective views of two preferred embodiments of the present invention. The present invention further provides two filter bodies 100 having shapes similar to the nasal cavity. In other words, the shape of each filter body 100 is preferably an oval shape or an egg shape. The difference between the present embodiment and the above-mentioned embodiments is that the filter bodies 100 of the present embodiment further disposed with a second axial hole 120. The filter material 300 is preferably disposed in the first axial hole 110 while one end of the second axial hole 120 is disposed on the covering 350. However, in other embodiments, the filter material 300 may also be disposed in only the second axial hole 120 while the first axial hole 110 is disposed on the covering 350. Indeed, the filter material 300 can even be disposed in both the first axial hole 110 and the second axial hole 120. In the embodiment shown in FIGS. 6a and 6b, the second axial hole 120 are preferably hollow holes having the same diameter throughout the hollow hole. However, in other embodiments, two ends of the second axial hole 120 may also be a hole having different diameters. Moreover, the two ends of the first axial hole 110 preferably have different diameters.

In the embodiment shown in the FIG. 6b, the second axial hole 120 is preferably disposed with only the covering 350 and not the filter material 300. However, in other embodiments, the filter material 300 can be disposed with the covering 350 at one end and with passageway 310 (shown in FIG. 4). The filter material 300 is then inserted into the second axial hole 120. In the present embodiment, at least one brace 320 is further disposed on the bottom surface 104 of the second axial hole 120 for positioning the covering 350. The covering 350 can be axially moved along the brace 320 and covers the second axial hole 120 entirely. The material of the covering 350 preferably includes plastic, silica gel (silicon), rubber, PP, PE and the combinations thereof. The rest of the structure of the covering 350 is described above and will not be repented again here.

While the covering 350 is disposed on the bottom end 114 of the second axial hole 120, the filter material 300 is disposed in the first axial hole 110; the air enters the first axial hole 110 during inhalation and cannot enter the second axial hole 120 because the second axial hole 120 is blocked by the covering 350. The harmful aerosol can be filtered out by the filter material 300 in the first axial hole 110 to prevent the user from inhaling the harmful substrates. On the other hand, the air can be exhaled through the first axial hole 110 and the second axial hole 120 simultaneously during exhalation. Specifically, the covering 350 disposed on the second axial hole 120 will be pushed/moved downward to facilitate the air exhalation.

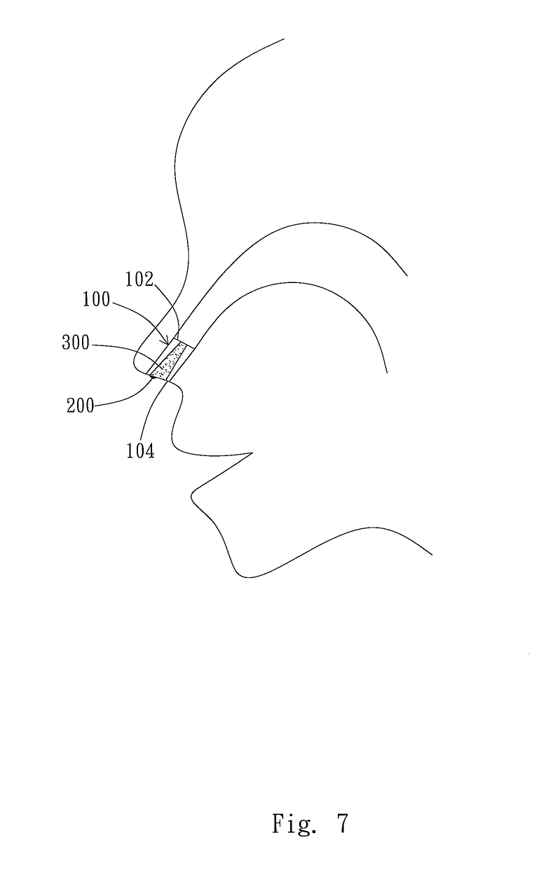

FIG. 7 shows an operation view of the present invention. When the filter body 100 is inserted into the nasal cavity, the top surface 102 is preferably disposed close to the inner part of the nasal cavity while the bottom surface 104 is positioned close to the nostril. The connecting portion 200 is positioned close to the nostril as well. Exert a force on the connecting portion 200 or the two filter bodies 100 can pull the filter body 100 directly out of the nasal cavity. In the present embodiment, the filter material 300 cannot be easily taken out of the first opening 112 of the top surface 102 even when the user inhales with excessive force which may influence the filtering. However, if the user wants to take the filter material 300 out, he/she can exhale with excessive force or use other methods, etc. Therefore, the present invention is very easy to replace the filter material 300 and cleans the filter body 100 for repeated usage.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A nasal filter, comprising:
two filter bodies respectively having a top surface, a bottom surface and a first axial hole, the first axial hole penetrating the top surface and the bottom surface, and on the top surface and the bottom forming a first opening and a second opening respectively, wherein the diameter of the first opening is smaller then the second opening;
a connecting portion having two ends connected with the two filter bodies respectively; and
two filter materials respectively disposed in each of the two first axial holes, wherein the diameter of the filter material is bigger then or equal to the second opening.

2. The nasal filter of claim 1, wherein the two ends of the connecting portion are disposed on an outer surface or the bottom surface of the filter body.

3. The nasal filter of the claim 1, wherein one end of the filter material has at least one brace for positioning a covering, and the covering is axially movable disposed on the brace.

4. The nasal filter of the claim 3, wherein the brace has a gap, the covering has an extending portion and a protrusion portion, the protrusion portion is disposed on the extending portion, and the diameter of the gap is smaller then the protrusion portion.

5. The nasal filter of the claim 1, wherein the filter material further has a passageway.

6. The nasal filter of claim 1 further comprises a second axial hole in each filter body, wherein an interval is disposed between the second axial hole and the first axial hole.

7. The nasal filter of claim 6, wherein the bottom surface of the second axial hole has at least one brace for positioning a covering, and the covering is axially movable disposed on the brace.

8. The nasal filter of claim 7, wherein the brace has a gap, the covering has an extending portion disposed vertically thereto, the extending portion has a protrusion portion, and the diameter of the gap is smaller then the protrusion portion.

9. The nasal filter of claim 1, wherein the shape of the filter body is selected form one of a ring-tubby shape, a sphere shape, an ellipse-tubby shape and an ob-ovum ellipse tubby shape.

10. The nasal filter of claim 1, wherein the filter material includes an elastic material.

11. The nasal filter of claim 1, wherein the material of the filter body is selected from one of the group consisting of silica gel (silicon), plastic, rubber and the combinations thereof.

12. The nasal filter of claim 1, wherein the two filter bodies and the connecting portion are integrately formed.

13. The nasal filter of claim 1, wherein the material of the connecting portion is selected from one of the group consisting of silica gel (silicon), plastic, rubber and the combinations thereof.

14. The nasal filter of claim 1, wherein the material of the two filter materials are selected from one of filter net, activated carbon material, non-woven fabric and filter cotton.

15. A nasal filter, comprising:
two filter bodies having a top surface, a bottom surface, a first axial hole and a second axial hole respectively, the first axial hole and the second axial hole respectively penetrating the top surface and the bottom surface, wherein the second axial hole further forms a first opening and a second opening on the top surface and the bottom surface respectively, and the diameter of the first opening is smaller then or equal to the second opening;
a connecting portion having two ends connected with an outer surface of the two filter bodies; and
two filter materials respectively disposed in the first axial hole, and at least one brace and a covering disposed on the bottom surface of the first axial hole, the covering axially movable along the brace, wherein the diameter of the filter material is bigger then or equal to the second opening.

16. The nasal filter of claim 15, wherein the brace has a gap, the covering has an extending portion disposed vertically thereto, the extending portion further has a protrusion portion, and the diameter of the gap is smaller then the protrusion portion.

17. The nasal filter of claim 15, wherein the filter material further has a passageway, and the passageway is disposed corresponding to the covering.

18. The nasal filter of claim 15, wherein at least one brace is disposed on the bottom surface of the first axial hole for positioning a covering, and the covering is axially movable along the brace.

19. The nasal filter of claim 18, wherein the brace further has a gap, the covering has an extending portion and a protrusion portion, the protrusion portion is disposed on the extending portion, and the diameter of the gap is smaller then the protrusion portion.

20. The nasal filter of claim 15, wherein the material of the filter material is selected from one of a ring-tubby shape, a sphere shape, an ellipse-tubby shape and an ob-ovum ellipse tubby shape.

21. The nasal filter of claim 15, wherein the material of the filter body is selected from one of the group consisting of silica gel (silicon), plastic, rubber and the combinations thereof.

22. The nasal filter of claim 15, wherein the two filter bodies and the connecting portion are integrately formed.

23. The nasal filter of claim 15, wherein the material of the connecting portion is selected from one of the group consisting of silica gel, plastic, rubber and the combinations thereof.

24. The nasal filter of claim 15, wherein the material of the filter material is selected from one of filter net, activated carbon material, non-woven fabric and filter cotton.
